(19) United States
(12) Patent Application Publication
(10) Pub. No.: US 2025/0358754 A1
(43) Pub. Date: Nov. 20, 2025

(54) WIRELESS SYNCHRONIZATION

(71) Applicant: Nokia Technologies OY, Espoo (FI)

(72) Inventor: Stepan KUCERA, Munich (DE)

(21) Appl. No.: 19/116,706

(22) PCT Filed: Jun. 21, 2023
(86) PCT No.: PCT/FI2023/050376

§ 371 Date: Mar. 28, 2025

(30) Foreign Application Priority Data
Sep. 30, 2022 (FI) 20225865

(51) Int. Cl. H04W 56/00; H04L 5/00; H04W 52/52; H04W 64/00

(52) U.S. Cl. CPC H04W 56/0015; H04L 5/0051; H04W 52/52; H04W 64/00

(57) ABSTRACT

According to an example aspect of the present invention, there is provided an apparatus configured at least to function as a node in a wireless communication system, participate in a synchronization process with at least one target node of the wireless communication system, wherein the apparatus is configured to transmit, as part of the synchronization process, via node-to-node signalling, a reference signal at a time instant specified in assistance information received from the wireless communication system, and report, as part of the synchronization process, to the wireless communication system, a time of receipt of a signal from each one of the at least one target node.

### FIELD

The present disclosure relates to wireless synchronization, for example for wireless positioning.

### BACKGROUND

Synchronization between apparatuses, such as user equipments, UEs, is of interest in several applications, such as messaging, streaming and positioning UEs. For, example, positioning of a UE in a cellular network involves deriving an estimate for the current location of the user equipment. The location estimate may be relative or absolute, meaning expressing the location estimate in terms of other units or in geo-coordinates, respectively. Various mechanisms are in use in cellular networks, NWs, to derive the estimate for the current location. For example, the estimate may be derived from time difference of arrival information, and/or it may be assisted with detectable short-range networks, such as wireless local area network, WLAN, hot spots.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to function as a node in a wireless communication system, participate in a synchronization process with at least one target node of the wireless communication system, wherein the apparatus is configured to transmit, as part of the synchronization process, via node-to-node signalling, a reference signal at a time instant specified in assistance information received from the wireless communication system, and report, as part of the synchronization process, to the wireless communication system, a time of receipt of a signal from each one of the at least one target node.

According to a second aspect of the present disclosure, there is provided an apparatus comprising at least one processing core and at least one memory storing instructions that, when executed by the at least one processing core, cause the apparatus at least to function as a node of a wireless communication system, participate as a target node in a synchronization process with at least one further node of the wireless communication system, wherein the apparatus is configured to inform a further node of the wireless communication system of a time instant of receipt, via node-to-node signalling, of a reference signal from each one of the at least one further node, and transmit, as part of the synchronization process, a signal in uplink or sidelink at a time instant specified in assistance information received from the wireless communication system.

According to a third aspect of the present disclosure, there is provided an apparatus comprising at least one processing core and at least one memory storing instructions that, when executed by the at least one processing core, cause the apparatus at least to function as a node of a wireless communication system, participate in a synchronization process, wherein the apparatus is configured to provide first assistance information to at least one further node instructing when to transmit, via node-to-node signalling, a reference signal, and to provide second assistance information to a target node instructing when to transmit a signal in uplink or sidelink, and receive, as part of the synchronization process, indications from the at least one further node concerning when each one of the at least one further node received the signal from the target node, and at least one indication from the target node concerning when the target node received each one of the reference signals.

According to a fourth aspect of the present disclosure, there is provided a method comprising functioning as a node of a wireless communication system, participating in a synchronization process with at least one target node of the cellular communication system, wherein the synchronization process comprises transmitting, via node-to-node signalling, a reference signal at a time instant specified in assistance information received from the wireless communication system, and reporting, as part of the synchronization process, to the wireless communication system, a time of receipt of a signal from each one of the at least one target node.

According to a fifth aspect of the present disclosure, there is provided a method comprising functioning as a node of a wireless communication system, participating as a target node in a synchronization process with at least one further node of the wireless communication system, wherein a further node of the wireless communication system is informed of a time instant of receipt, via node-to-node signalling, of a reference signal from each one of the at least one further node, and transmitting, as part of the synchronization process, a signal in uplink or sidelink at a time instant specified in assistance information received from the wireless communication system.

According to a sixth aspect of the present disclosure, there is provided a method comprising functioning as a node of a wireless communication system, participating in a synchronization process, wherein first assistance information is provided to at least one further node instructing when to transmit, via node-to-node signalling, a reference signal, and wherein second assistance information is provided to a target node instructing when to transmit a signal in uplink or sidelink, and receiving, as part of the synchronization process, indications from the at least one further node concerning when each one of the at least one further node received the signal from the target node, and at least one indication from the target node concerning when the target node received each one of the reference signals.

According to a seventh aspect of the present disclosure, there is provided an apparatus comprising means for functioning as a node of a wireless communication system, means for participating in a synchronization process with at least one target node of the wireless communication system, wherein the synchronization process comprises transmitting, via node-to-node signalling, a reference signal at a time instant specified in assistance information received from the wireless communication system, and means for reporting, as part of the synchronization process, to the wireless communication system, a time of receipt of a signal from each one of the at least one target node.

According to an eighth aspect of the present disclosure, there is provided an apparatus comprising means for functioning as a node of a wireless communication system, means for participating as a target node in a synchronization process with at least one further node of the cellular communication system, wherein a further node of the wireless communication system is informed of a time instant of receipt, via node-to-node signalling, of a reference signal from each one of the at least one further node, and means for transmitting, as part of the synchronization process, a signal in uplink or sidelink at a time instant specified in assistance information received from the wireless communication system.

According to a ninth aspect of the present disclosure, there is provided an apparatus comprising means for functioning as a node of a wireless communication system, means for participating in a synchronization process, wherein first assistance information is provided to at least one further node instructing when to transmit, via node-to-node signalling, a reference signal, and wherein second assistance information is provided to a target node instructing when to transmit a signal in uplink or sidelink, and means for receiving, as part of the synchronization process, indications from the at least one further node concerning when each one of the at least one further node received the signal from the target node, and at least one indication from the target node concerning when the target node received each one of the reference signals.

According to a tenth aspect of the present disclosure, there is provided a non-transitory computer readable medium having stored thereon a set of computer readable instructions that, when executed by at least one processor, cause an apparatus to at least function as a node of a wireless communication system, participate in a synchronization process with at least one target node of the wireless communication system, wherein the apparatus is configured to transmit, as part of the synchronization process, via node-to-node signalling, a reference signal at a time instant specified in assistance information received from the wireless communication system, and report, as part of the synchronization process, to the wireless communication system, a time of receipt of a signal from each one of the at least one target node.

According to an eleventh aspect of the present disclosure, there is provided a non-transitory computer readable medium having stored thereon a set of computer readable instructions that, when executed by at least one processor, cause an apparatus to at least function as a node of a cellular communication system, participate as a target node in a synchronization process with at least one further node of the cellular communication system, wherein the apparatus is configured to inform a further node of the wireless communication system of a time instant of receipt, via node-to-node signalling, of a reference signal from each one of the at least one further node, and transmit, as part of the synchronization process, a signal in uplink or sidelink at a time instant specified in assistance information received from the wireless communication system.

According to a twelfth aspect of the present disclosure, there is provided a non-transitory computer readable medium having stored thereon a set of computer readable instructions that, when executed by at least one processor, cause an apparatus to at least function as a node of a wireless communication system, participate in a synchronization process, wherein the apparatus is configured to provide first assistance information to at least one further node instructing when to transmit, via node-to-node signalling, a reference signal, and to provide second assistance information to a target node instructing when to transmit a signal in uplink or sidelink, and receive, as part of the synchronization process, indications from the at least one further node concerning when each one of the at least one further node received the signal from the target node, and at least one indication from the target node concerning when the target node received each one of the reference signals.

### BRIEF DESCRIPTION OF THE DRAWINGS

FIG. 1 illustrates an example system in accordance with at least some embodiments of the present invention;

FIG. 2 illustrates signal timing in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Processes are herein described, which enable more precise apparatus or UE synchronization which is usable in several applications, such as messaging and positioning based on observed time difference of arrival, OTDOA. In detail, a set of anchor UEs transmit reference signals, and a target UE, or a set of plural target UEs, transmits a signal in uplink or sidelink as part of the synchronization process. The target UE reports timestamps of receipt of the reference signals at the target UE, and the anchor UEs report timestamps of receipt of the signal from the target UE as part of the synchronization process. The timestamps indicate a time instant of receipt in terms of a clock of the receiving UE. The timestamps are reported to a node, such as, for example, a core network node, to derive an estimate of synchronization parameters between the anchor UEs. This enables e.g. OTDOA positioning with an accuracy which is up to an order of magnitude less uncertain than without using the signal from the target UE. The reference signals are transmitted from the anchor UEs, or from at least one anchor apparatus, in the sidelink, by which it is meant direct UE-to-UE communication wherein a wireless signal is transmitted from a first UE and received in a second UE, without the signal being re-transmitted along the way by any other node, such as a base station, for example. The signal from the target UE may be transmitted in sidelink or uplink. While discussed herein predominantly in terms of UEs, in general also other kinds of nodes or apparatuses may be configured to use the synchronization and/or positioning mechanism herein disclosed. UEs are illustrative examples of such nodes or apparatuses.

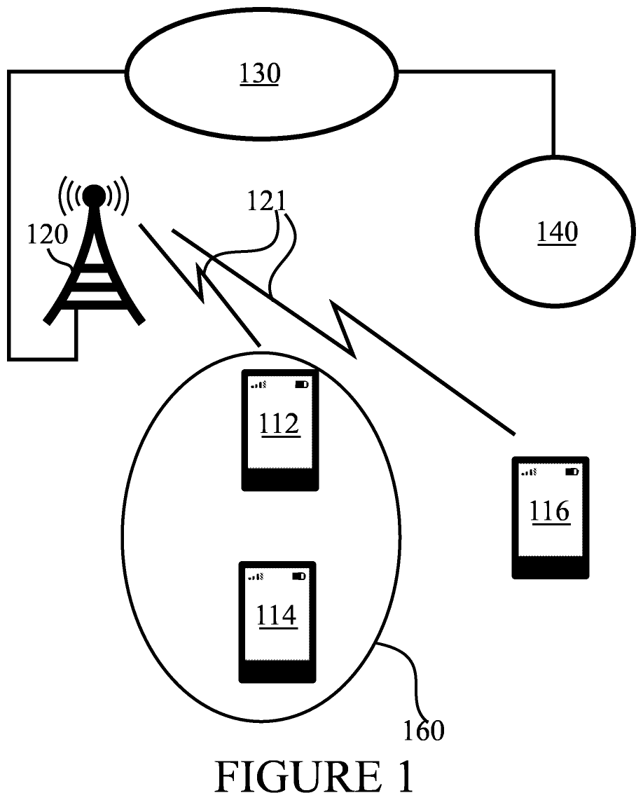

FIG. 1 illustrates an example system in accordance with at least some embodiments of the present invention. A cellular communication system comprises a radio-access network and a cellular core network 130. The radio-access network comprises at least one base station 120, and it may comprise several hundred or even several thousand base stations. Base stations may be configured to control at least one cell each. Examples of cellular communication systems include fifth generation, 5G, systems, wideband code division multiple access, WCDMA, systems and long term evolution, LTE, systems.

User equipments, UE, 112, 114, 116 are communicatively coupled with base station 120 via wireless links 121, which conform to a same communication standard as UEs 112, 114, 116 and base station 120, to achieve interoperability. Wireless links 121 may comprise a downlink, DL, involving communication from the base station toward UEs, and an uplink, UL, involving communication from UEs toward the base station. UEs 112, 114, 116 may each comprise a smartphone, a cellular phone, a tablet, an internet-of-things node, a laptop or desktop computer or, for example, a connected car communication module, as applicable.

The UEs need not be of the same type. In general a UE may be a mobile device, such as a personal media device, or it may be fixedly installed, for example when the UE is a smart metering device installed to read out and provide to a back-end server information on water flow or electricity usage. In some embodiments, a different term than UE may be used depending on which specific technology is employed, in most general terms an apparatus configured to perform as described herein may be a node of a wireless communication network. An external network 140, such as the Internet, may be accessed via core NW 130.

In FIG. 1, a group 160 of UEs 112, 114 forms a group of anchor UEs. These UEs are close to each other in the sense that, for example, that they are within sounding distance of a target UE 116 and capable of communicating with the target UE 116 via direct UE-to-UE communication without using a base station, such as base station 120, or a relay device. Such communication may be referred to a sidelink, SL, communication. In some embodiments, however, a sidelink relay may be employed in sidelink communication, wherein sidelink signals are transmitted by nodes such as UEs, received and re-transmitted by a sidelink relay, and received by a second node, such as a second UE, such that the signal does not traverse a base station. Sidelink communication resources, for example used in communicating in sidelink via a sidelink relay, may be distinct from uplink communication resources. By sounding distance it is meant a distance within which UEs can detect other UEs and determine, at least partially, a direction and distance to these other UEs. In general, not all UEs 112, 114, 116 need to have the same serving base station 120 although this is the case in FIG. 1 for the sake of clarity of the illustration.

Anchor UEs 112, 114, forming anchor UE group 160, may each have a known location, or they may have an accurate positioning capability. In some cases, anchor UEs are normal UEs assigned to participate in a synchronization process, or a positioning process which comprises a synchronization process, in the role of an anchor UE. An accurate positioning capability may comprise multi-constellation satellite positioning or an interface to an airspace control system, for example. An anchor UE is capable of transmitting and receiving electromagnetic pulses usable in estimating an distance of a UE to another UE. These pulses may be comprised in sidelink, SL, communication between the involved UEs. By sidelink it is meant device-to-device, such as UE-to-UE, communication which does not traverse a base station device, wherein one device transmits electromagnetic energy which is received by a receiver comprised in the receiving device, in other words, the communication is direct without traversing any other node, such as base station or relay.

Anchor UEs may be configured to provide positioning measurements, such as reference signal time difference, RSTD, reference signal received power, RSRP, and/or receive-transmit, Rx-Tx, time differences. For example for OTDOA positioning processes, anchor UEs are configured to transmit sidelink positioning reference signals, PRS, for the UE to be positioned to detect. The UE to be positioned in a positioning process is referred to as a target UE. The anchor UEs may be configured by a core network node, such as a location management function, LMF, wherein such configuration may take the form of assistance information provided from the core network node to each anchor UE. In case the process is a positioning process, the assistance information is positioning assistance information. The assistance information defines, when each anchor UE is to transmit its reference signal in sidelink and, optionally, also which transmission resources the anchor UE is to use for the transmission of the reference signal. Examples of transmission resources are frequency bands and spreading codes. The target UE may be provided the assistance information as well, to enable it to detect the SL reference signals transmitted by the anchor UEs. In some cases a single anchor UE is used, for example where the serving base station of the target UE also participates in a positioning process, performing effectively a role of an anchor UE by transmitting a reference signal in the downlink.

OTDOA positioning may be performed such that the anchor UEs transmit their reference signals in sidelink, the target UE receives each one of them and records a timestamp of the moment each reference signal is received in circuitry of the target UE. These timestamps may then be reported from the target UE to the cellular system, such as to the core network node, such as to the LMF, which may use them to determine the differences in signal propagation times between the target UE and each one of the anchor UEs, to estimate their relative locations. Where absolute locations of the anchor UEs are known, an absolute location estimate for the target UE may likewise be determined. OTDOA is an attractive method of low complexity, known from base station-based positioning, that can advantageously be operated on both uplink and downlink.

A challenge in sidelink based OTDOA positioning lies in synchronization of anchor UEs. High-accuracy OTDOA requires accurate timing synchronization between the participating anchor UEs, which makes direct application of OTDOA methods to wireless sidelink scenarios challenging. More specifically, in base station-based OTDOA scenarios, fibre links can be used to achieve synchronization by using the WhiteRabbit synchronization technology, for example, yet in sidelink scenarios synchronization is typically done only with respect to the serving base station with precision at the order of one cyclic prefix, CP. An error at the order of a cyclic prefix is multiple orders of magnitude bigger than a typical positioning target precision of 0.5-2 metres.

It has been discovered, that the synchronization between anchor UEs may be significantly enhanced by supplementing the synchronization mechanism, for example a synchronization process forming part of an OTDOA positioning process, by a signal transmitted from the target UE. In detail the assistance information provided from the cellular system, in addition to defining the transmission times and, optionally, transmission resources of the reference signals from the anchor UEs, also defines a transmission time and, optionally, transmission resources of a signal from the target UE. This enables detection of the signal from the target UE in the anchor UEs, wherein each anchor UE records a timestamp of the moment the signal from the target UE is received in circuitry of the anchor UE. These timestamps are reported from the anchor UEs to the cellular system, such as to the core network, such as to the LMF. There is thus more information that may be used in determining the synchronization between the anchor UEs, significantly enhancing synchronization accuracy, which in turn significantly enhances the accuracy of processes, such as positioning processes, such as OTDOA positioning processes, which rely on the synchronization between anchor UEs.

The signal transmitted from the target UE may comprise an automatic gain control, AGC, symbol. AGC symbols are used for power level control in sidelink. In detail, to decode a received signal successfully, a receiver must receive the signal at a power level which is sufficiently strong, above a minimum power threshold, but within a saturation limit of its power amplifier, since too strong a signal would be clipped. Consequently, for the receiver circuitry to adapt to signals of varying strengths, as the receiver doesn't know in advance how strong the incoming signal is, AGC is used. More specifically, the first symbol, the AGC symbol, in a transmitted sequence is of a known structure and power, and the receiver may be configured to use it to calibrate its circuitry in order to receive the subsequent symbols correctly. The AGC symbol itself does not carry actual data. The AGC symbol is useful as before a positioning process ends, the participating UEs, anchors and the target, do not necessarily know how far away they are from each other. The signal from the target UE may be transmitted in uplink or sidelink. Uplink may be used for the signal from the target UE as long as the anchor UEs are capable of receiving uplink transmissions. Thus the AGC symbol may be provided in an uplink signal as well, which is usually not done since uplink uses separate power control mechanisms. In some embodiments, the AGC is implemented by a prior transmission in the sidelink resource pool, for example as sidelink control information, SCI, grant containing and ACG component, or an SCI grant for the UL SRS signal in the SL resource pool.

Since the purpose of the signal from the target UE is to enhance synchronization, it is beneficially transmitted as a brief signal, which corresponds to transmitting it using a wide bandwidth. For example, the signal may occupy an entire preconfigured bandwidth used for direct UE-to-UE signalling in the synchronization and/or OTDOA positioning process. Thus using a wider bandwidth provides the effect that synchronization/positioning accuracy is enhanced. In some embodiments, the signal from the target UE is both wideband and comprises the AGC symbol.

The signal from the target UE may be transmitted before the reference signals from the anchor UEs, or after the reference signals. It may also be transmitted in the midst of the reference signals. This signal may take the form of a positioning reference signal when transmitted in sidelink, or an uplink sounding reference signal, SRS, when transmitted in the uplink, for example. Together with the timestamps indicating time instances of receipt at the target UE of the reference signals from the anchor UEs, the timestamps from the anchor UEs indicating time instances of receipt at the anchor UEs of the signal from the target UE enable determination of the timing offset of each anchor UE with respect to the target UE's clock. The timestamps may also be used in correcting anchor UE timing offset with respect to the target UE to achieve inter-anchor OTDOA synchronization for precise OTDOA positioning.

The corrections based on the timestamps indicating times of receipt of the signal from the target UE may be performed either directly in the anchor UE clock, for example where a single target UE is to be positioned, or indirectly as part of OTDOA post-processing, for example when there are several target UEs to be positioned by the same set 160 of anchor UEs. A periodic repetition of this synchronization scheme permits synchronization, and associated positioning, tracking even under mobility conditions. This synchronization scheme is distributed in nature with no need for centralized processing and/or centralized parameter control.

Alternatively to just one target UE, there may be plural target UEs forming a set of target UEs. Each of the target UEs in the set of target UEs is configured, by the assistance information from the cellular system, to transmit the signal described above. The assistance information defines for each target UE a time when the transmission should be made, to prevent the target UEs from transmitting their signals at the same time in case the same resources are used for these signals. The signals from the target UEs may identify the transmitting target UE, in particular in case there is more than one target UE in the set of target UEs.

Whether in the case of single or plural target UEs, a core network node, such as LMF, first sets up a sidelink OTDOA positioning session via the serving base station 120, wherein as part of the setting up anchor UEs are selected for a given target UE, and all PRS and/or SL PRS resources are allocated and activated. All participating UEs, including the anchor UEs, have a basic synchronization with the network, for example through the UL timing advance value maintained for the serving base station. In sidelink scenarios however, in conventional scenarios they do not have OTDOA-grade mutual synchronization. This is due to non-negligible delays in the propagation of reference signals, and has the effect that the mutual synchronization the UEs have is insufficient for precise OTDOA positioning with 1-2 metre resolution.

As part of a positioning session initiation, the core network node, such as LMF, distributes the positioning assistance information to the anchor and target UEs. The assistance information describes the specific parameters SL PRS resource configuration to all UEs, such as transmission times of the signals. In case a base station participates in the process as an anchor, its DL PRS parameters are also defined by the core network node, such as LMF. The assistance information also defines the UL SRS signal (or another UL signal) of the target UE whose transmission will be used to achieve a high-precision OTDOA synchronization of the anchor UEs, in case the signal from the target UE(s) is an uplink signal. The assistance information may also be used to define a sidelink-based signal from the target UE, in case the target UE uses sidelink to transmit its signal as part of the positioning process.

Once the positioning session is configured and active, the anchors engage in transmitting their SL PRS signals as configured by the assistance information. In case the base station 120 is one of the anchors, it too transmits its PRS as defined in the assistance information, for example from the core network. In general, these transmissions may be repeated to enable OTDOA-based position tracking. The core network node, such as LMF, may be configured to ensure, by compiling the assistance information appropriately, that in response to, or prior to, a batch of OTDOA SL PRS signals (e.g. the first one), the target UE transmits an UL SRS signal or a sidelink positioning signal.

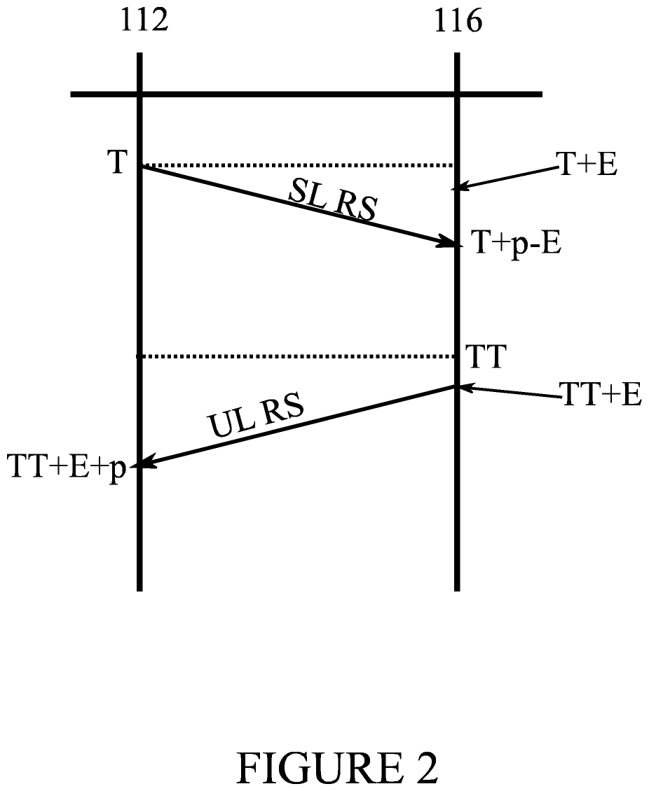

FIG. 2 illustrates signal timing in accordance with at least some embodiments of the present invention. On the vertical axes are disposed anchor UE 112 and target UE 116. Time advances from the top toward the bottom.

In the illustrated synchronization process, the assistance information defines that anchor UE 112 is to transmit its reference signal, using sidelink, at time instant T. This signal is denoted “SL RS” in FIG. 2 and its slope relates to the finite propagation speed of the signal. The assistance information likewise defines that target UE 116 is to transmit its signal at time instant TT. This signal is denotes “UL RS” in FIG. 2, as in this example this is an uplink signal, and not a sidelink signal. E denotes a synchronization difference between anchor UE 112 and target UE 116. The timestamp of receipt of the reference signal is “T+p−E”, where p is the signal propagation time between the anchor and target UEs, and the timestamp of receipt of the signal from target UE 116 at the anchor UE 112 is “TT+E+p”.

Each anchor UE reports to e.g. the LMF the local reception timestamp of the signal from the target UE. The target UE itself reports to e.g. the LMF the local reception timestamp of the anchor UE SL reference signals. Given the knowledge of the transmit timing of the reference signals and target UE signal, the node the timestamps are reported to, e.g. the LMF, may then compute the timing error “E” between the target UE and each individual anchor UE. These enable also determining timing correction factors, i.e. synchronization, between anchors via the target UE clock reference.

More specifically, the target UE reports (in addition to standard OTDOA measurements) the local reception time “T+p−E” of each anchor UE SL reference signal, wherein T denotes the local transmission time of the SL reference signal from the anchor UE and p is the propagation delay, as noted above. Similarly, the anchor UE reports the local reception time TT+E+p of the signal from the target UE, transmitted by the target UE at local time TT+E wherein TT denotes the transmission time in terms of the clock of anchor UE 112.

Given the anchor UE inputs TT+E+p and T, and the target UE inputs TT+E and T+p, the node to which the timestamps were reported, e.g. the LMF, may first computes propagation time p for the associated anchor as

$$p = [ ( T T + E + p ) - ( T ) - ( ( T T + E ) - ( T + p ) ] / 2$$

The propagation time p is then used either in the node to which the timestamps were reported, e.g. the LMF, or directly in the anchor UE as a timing offset correction term. In the former case, the node, e.g. LMF, computes the correction differences among the anchor UEs which are the added to the OTDOA reports by the target UE. This approach may be useful when the same set of anchor UEs is used concurrently by multiple target UEs and the physical correction of their clock by using multiple timing advances is not possible. But if only one target UE is active, the node, e.g. LMF, can also instruct each anchor UE to set their clock such that when the reference signal is received, the clock indicates time T+p. This is equivalent to correction of the error E as time T+p−E is set to be equal to the time T+p.

It is irrelevant whether the signal from the target UE is transmitted before or after the reference signals from the anchor UEs. In some embodiments, it is transmitted prior to the reference signal transmissions, or between them. All that matters is proper reporting of the transmission and reception times of these signals, the order of transmission of the various signals is not relevant.

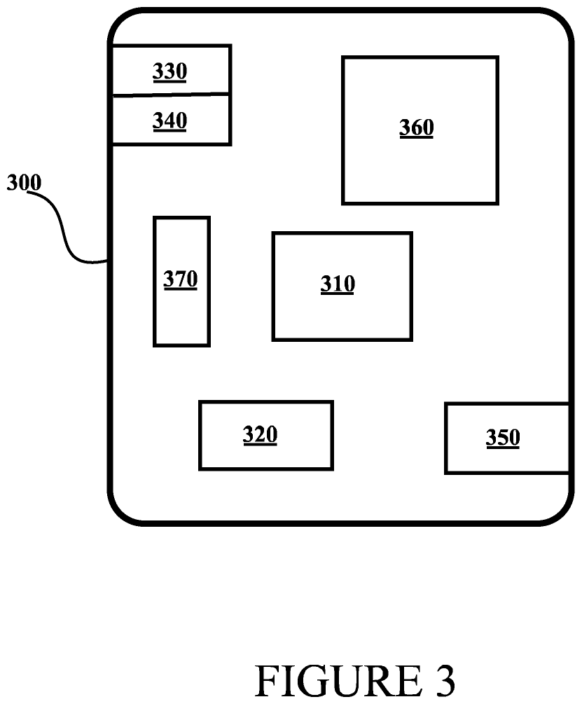

FIG. 3 illustrates an example apparatus capable of supporting at least some embodiments of the present invention. Illustrated is device 300, which may comprise, for example, a mobile communication device such as a UE or, in applicable parts, a core network node such as an LMF. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as functioning, participating, reporting, providing, receiving and/or transmitting. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or core network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information.

Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

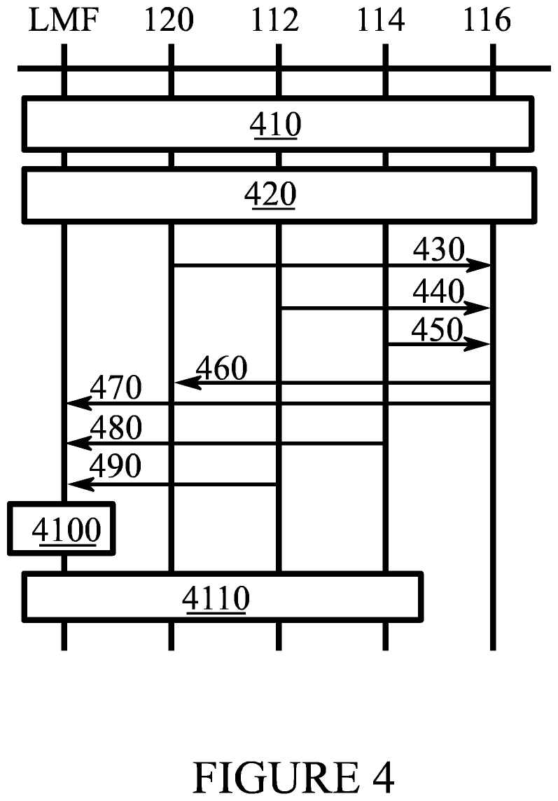

FIG. 4 illustrates signalling in accordance with at least some embodiments of the present invention. On the vertical axes are disposed, from the left, the LMF, serving base station 120, anchor UEs 112 and 114, and finally on the right, target UE 116. Time advances from the top toward the bottom. In the illustrated example, the serving base station 120 functions as one of the anchors. In some other embodiments, only UEs serve as anchors.

In phase 410, an OTDOA positioning process is set up based on an existing, coarse, anchor synchronization. In phase 420 the assistance information, in this case positioning assistance information, is disseminated by the LMF to UEs and base station 120 participating in the positioning process. As described above, the positioning assistance information defines when positioning reference signals, PRS, are to be sent by base station 120 and anchor UEs 112, 114, and when target UE 116 should transmit its signal as part of the positioning process. The assistance information also facilitates reception of these signals. The positioning assistance information may also define transmission resources for these reference signals from the anchors and the signal from the target UE. In the illustrated process, the base station 120 participates as an anchor and the signal from target UE 116 is an uplink signal, but as noted above the signal from the target UE may be a sidelink signal as well, in particular if the serving base station does not participate in the positioning process as an anchor.

In phase 430, base station 120 transmits in downlink to provide a PRS signal to target UE 116. In phases 440 and 450, anchor UEs 112 and 114, respectively, transmit sidelink PRS signals to target UE 116. Target UE 116 records timestamps indicating time instants of receipt at target UE 116 of the signals of phases 430, 440 and 450. The signals of phases 430, 440 and 450 are transmitted at times defined in the positioning assistance information disseminated in phase 420.

In phase 460 target UE 116 transmits its signal, in this case an uplink signal, as instructed in the positioning assistance information. Its time instances of receipt are recorded as timestamps in each of anchor UEs 112 and 114, and in base station 120. In phase 470, the target UE 116 reports the receipt timestamps of the signals of phases 430, 440 and 450 to the LMF. In phases 480 and 490 anchor UEs 114 and 112, respectively, report to the LMF their timestamps of receipt of the signal from target UE 116 (phase 460). Also base station 120 reports to the LMF when it received the signal of phase 460.

In phase 4100, the LMF determines anchor UE timing offsets based on the timestamps reported to it in phases 470, 480 and 490, and by the base station, and in phase 4110 timing offset corrections are carried out based on the determinations reached in phase 4100. High-accuracy OTDOA positioning may then take place subsequent to phase 4110.

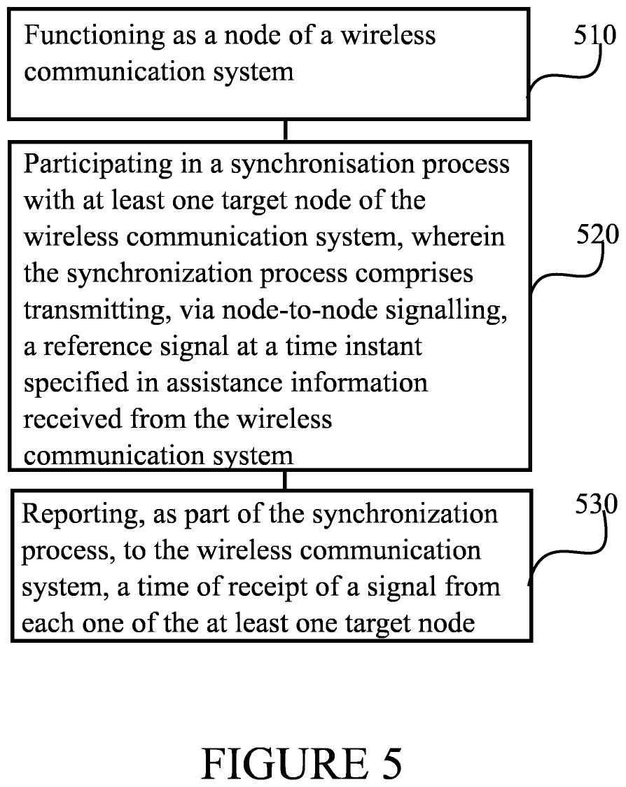

FIG. 5 is a flow graph of a method in accordance with at least some embodiments of the present invention. The phases of the illustrated method may be performed in an anchor UE, for example, or in a control device configured to control the functioning thereof, when installed therein.

Phase 510 comprises functioning as a node, such as, for example, a user equipment, UE, of a wireless communication system. The wireless communication system may be a cellular communication system Phase 520 comprises participating in a synchronization process with at least one target node of the wireless communication system, wherein the synchronization process comprises transmitting, via node-to-node signalling, a reference signal at a time instant specified in assistance information received from the wireless communication system.

The node-to-node signalling may be direct node-to-node signalling, such as direct UE-to-UE signalling, for example. Finally, phase 530 comprises reporting, as part of the synchronization process, to the wireless communication system, a time of receipt of a signal from each one of the at least one target node.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in management of synchronization in wireless networks.

ACRONYMS LIST

| | |
|---|---|
| 5G | fifth generation |
| AGC | automatic gain control |
| DL | downlink |
| PRS | positioning reference signal |
| LMF | location management function |
| LTE | long term evolution |
| NW | network |
| OTDOA | observed time difference of arrival |
| RS | reference signal |
| SL | sidelink |
| SRS | sounding reference signal |
| UE | user equipment |
| UL | uplink |
| WCDMA | wideband code division multiple access |

REFERENCE SIGNS LIST

| | |
|---|---|
| 112, 114 | anchor UEs |
| 116 | target UE |
| 120 | base station |
| 121 | wireless links |
| 130 | core network |
| 140 | external network |
| 300-370 | structure of the device of FIG. 3 |
| 410-4110 | phases of the process of FIG. 4 |

### Technical Clauses:

Clause 1. An apparatus comprising at least one processing core and at least one memory storing instructions that, when executed by the at least one processing core, cause the apparatus at least to:
function as a node in a wireless communication system;
participate in a synchronization process with at least one target node of the wireless communication system, wherein the apparatus is configured to transmit, as part of the synchronization process, via node-to-node signalling, a reference signal at a time instant specified in assistance information received from the wireless communication system, and
report, as part of the synchronization process, to the wireless communication system, a time of receipt of a signal from each one of the at least one target node.

Clause 2. The apparatus according to Clause 1, wherein the synchronization process is comprised in an observed time difference of arrival, OTDOA, positioning process, wherein the at least one target node is positioned in the OTDOA positioning process, wherein the reference signal is a positioning reference signal and wherein the assistance information is positioning assistance information.

Clause 3. The apparatus according to Clause 1 or 2, wherein each one of the signals from the at least one target node comprises an automatic gain control symbol transmitted at a preconfigured power.

Clause 4. The apparatus according to Clause 2 or Clause 3 as dependent on Clause 2, wherein each one of the signals from the at least one target node occupies an entire preconfigured bandwidth used for node-to-node signalling in the OTDOA positioning process.

Clause 5. The apparatus according to any of Clauses 1-4, wherein each one of the signals from the at least one target node is an uplink or a sidelink signal.

Clause 6. The apparatus according to any of Clauses 1-5, wherein the apparatus is configured to receive the signal from the at least one target node before transmitting the reference signal.

Clause 7. The apparatus according to any of Clauses 1-5, wherein the apparatus is configured to receive the signal from the at least one target node after transmitting the reference signal.

Clause 8. An apparatus comprising at least one processing core and at least one memory storing instructions that, when executed by the at least one processing core, cause the apparatus at least to:
function as a node of a wireless communication system;
participate as a target node in a synchronization process with at least one further node of the wireless communication system, wherein the apparatus is configured to inform a further node of the wireless communication system of a time instant of receipt, via node-to-node signalling, of a reference signal from each one of the at least one further node, and
transmit, as part of the synchronization process, a signal in uplink or sidelink at a time instant specified in assistance information received from the wireless communication system.

Clause 9. The apparatus according to Clause 8, wherein the synchronization process is comprised in an observed time difference of arrival, OTDOA, positioning process, wherein the target node is positioned in the OTDOA positioning process, wherein each reference signal is a positioning reference signal and wherein the assistance information is positioning assistance information.

Clause 10. The apparatus according to Clause 8 or 9, wherein the apparatus is configured to transmit the signal in the uplink or the sidelink such that the signal comprises an automatic gain control symbol transmitted at a preconfigured power.

Clause 11. The apparatus according to any of Clauses 8-10, wherein the apparatus is configured to transmit the signal in the uplink or the sidelink such that the signal occupies an entire preconfigured bandwidth used for node-to-node signalling in the synchronization process.

Clause 12. An apparatus comprising at least one processing core and at least one memory storing instructions that, when executed by the at least one processing core, cause the apparatus at least to:
function as a node of a wireless communication system;
participate in a synchronization process, wherein the apparatus is configured to provide first assistance information to at least one further node instructing when to transmit, via node-to-node signalling, a reference signal, and to provide second assistance information to a target node instructing when to transmit a signal in uplink or sidelink, and
receive, as part of the synchronization process, indications from the at least one further node concerning when each one of the at least one further node received the signal from the target node, and at least one indication from the target node concerning when the target node received each one of the reference signals.

Clause 13. The apparatus according to Clause 12, wherein the synchronization process is comprised in an observed time difference of arrival, OTDOA, positioning process, wherein the target node is positioned in the OTDOA positioning process, wherein each reference signal is a positioning reference signal and wherein the first and second assistance information is positioning assistance information.

Clause 14. A method comprising:
functioning as a node of a wireless communication system;
participating in a synchronization process with at least one target node of the cellular communication system, wherein the synchronization process comprises transmitting, via node-to-node signalling, a reference signal at a time instant specified in assistance information received from the wireless communication system, and
reporting, as part of the synchronization process, to the wireless communication system, a time of receipt of a signal from each one of the at least one target node.

Clause 15. The method according to Clause 14, wherein the synchronization process is comprised in an observed time difference of arrival, OTDOA, positioning process, wherein the at least one target node is positioned in the OTDOA positioning process, wherein the reference signal is a positioning reference signal and wherein the assistance information is positioning assistance information.

Clause 16. The method according to Clause 14 or 15, wherein each one of the signals from the at least one target node comprises an automatic gain control symbol transmitted at a preconfigured power.

Clause 17. The method according to Clause 15 or Clause 16 as dependent on Clause 15, wherein each one of the signals from the at least one target node occupies an entire preconfigured bandwidth used for node-to-node signalling in the OTDOA positioning process.

Clause 18. The method according to any of Clauses 14-17, wherein each one of the signals from the at least one target node is an uplink or a sidelink signal.

Clause 19. The method according to any of Clauses 14-18, wherein the receiving of the signal from the at least one target node takes place before transmitting the reference signal.

Clause 20. The method according to any of Clauses 14-19, wherein the receiving of the signal from the signal from the at least one target node takes place after transmitting the reference signal.

Clause 21. A method comprising:
functioning as a node of a wireless communication system;
participating as a target node in a synchronization process with at least one further node of the wireless communication system, wherein a further node of the wireless communication system is informed of a time instant of receipt, via node-to-node signalling, of a reference signal from each one of the at least one further node, and
transmitting, as part of the synchronization process, a signal in uplink or sidelink at a time instant specified in assistance information received from the wireless communication system.

Clause 22. The method according to Clause 21, wherein the synchronization process is comprised in an observed time difference of arrival, OTDOA, positioning process, wherein the target node is positioned in the OTDOA positioning process, wherein each reference signal is a positioning reference signal and wherein the assistance information is positioning assistance information.

Clause 23. The method according to Clause 21 or 22, wherein the transmitting of the signal in the uplink or the sidelink takes place such that the signal comprises an automatic gain control symbol transmitted at a preconfigured power.

Clause 24. The method according to any of Clauses 21-23, wherein the transmitting of the signal in the uplink or the sidelink takes place such that the signal occupies an entire preconfigured bandwidth used for node-to-node signalling in the synchronization process.

Clause 25. A method comprising:
functioning as a node of a wireless communication system;
participating in a synchronization process, wherein first assistance information is provided to at least one further node instructing when to transmit, via node-to-node signalling, a reference signal, and wherein second assistance information is provided to a target node instructing when to transmit a signal in uplink or sidelink, and
receiving, as part of the synchronization process, indications from the at least one further node concerning when each one of the at least one further node received the signal from the target node, and at least one indication from the target node concerning when the target node received each one of the reference signals.

Clause 26. The method according to Clause 25, wherein the synchronization process is comprised in an observed time difference of arrival, OTDOA, positioning process, wherein the target node is positioned in the OTDOA positioning process, wherein each reference signal is a positioning reference signal and wherein the first and second assistance information is positioning assistance information.

Clause 27. An apparatus comprising:
means for functioning as a node of a wireless communication system;
means for participating in a synchronization process with at least one target node of the wireless communication system, wherein the synchronization process comprises transmitting, via node-to-node signalling, a reference signal at a time instant specified in assistance information received from the wireless communication system, and
means for reporting, as part of the synchronization process, to the wireless communication system, a time of receipt of a signal from each one of the at least one target node.

Clause 28. An apparatus comprising:
means for functioning as a node of a wireless communication system;
means for participating as a target node in a synchronization process with at least one further node of the cellular communication system, wherein a further node of the wireless communication system is informed of a time instant of receipt, via node-to-node signalling, of a reference signal from each one of the at least one further node, and
means for transmitting, as part of the synchronization process, a signal in uplink or sidelink at a time instant specified in assistance information received from the wireless communication system.

Clause 29. An apparatus comprising:
means for functioning as a node of a wireless communication system;
means for participating in a synchronization process, wherein first assistance information is provided to at least one further node instructing when to transmit, via node-to-node signalling, a reference signal, and wherein second assistance information is provided to a target node instructing when to transmit a signal in uplink or sidelink, and
means for receiving, as part of the synchronization process, indications from the at least one further node concerning when each one of the at least one further node received the signal from the target node, and at least one indication from the target node concerning when the target node received each one of the reference signals.

Clause 30. A non-transitory computer readable medium having stored thereon a set of computer readable instructions that, when executed by at least one processor, cause an apparatus to at least:
function as a node of a wireless communication system;
participate in a synchronization process with at least one target node of the wireless communication system, wherein the apparatus is configured to transmit, as part of the synchronization process, via node-to-node signalling, a reference signal at a time instant specified in assistance information received from the wireless communication system, and
report, as part of the synchronization process, to the wireless communication system, a time of receipt of a signal from each one of the at least one target node.

Clause 31. A non-transitory computer readable medium having stored thereon a set of computer readable instructions that, when executed by at least one processor, cause an apparatus to at least:
function as a node of a cellular communication system;
participate as a target node in a synchronization process with at least one further node of the cellular communication system, wherein the apparatus is configured to inform a further node of the wireless communication system of a time instant of receipt, via node-to-node signalling, of a reference signal from each one of the at least one further node, and
transmit, as part of the synchronization process, a signal in uplink or sidelink at a time instant specified in assistance information received from the wireless communication system.

Clause 32. A non-transitory computer readable medium having stored thereon a set of computer readable instructions that, when executed by at least one processor, cause an apparatus to at least:
function as a node of a wireless communication system;
participate in a synchronization process, wherein the apparatus is configured to provide first assistance information to at least one further node instructing when to transmit, via node-to-node signalling, a reference signal, and to provide second assistance information to a target node instructing when to transmit a signal in uplink or sidelink, and
receive, as part of the synchronization process, indications from the at least one further node concerning when each one of the at least one further node received the signal from the target node, and at least one indication from the target node concerning when the target node received each one of the reference signals.

1.-32. (canceled)

33. An apparatus comprising:
at least one processing core; and
at least one memory storing instructions that, when executed by the at least one processing core, cause the apparatus at least to:
function as a node in a wireless communication system;
participate in a synchronization process with at least one target node of the wireless communication system, wherein the apparatus is configured to transmit, as part of the synchronization process, via node-to-node signalling, a reference signal at a time instant specified in assistance information received from the wireless communication system, wherein the synchronization process is comprised in an observed time difference of arrival (OTDOA) positioning process, wherein the at least one target node is positioned in the OTDOA positioning process, wherein the reference signal is a positioning reference signal and wherein the assistance information is positioning assistance information, wherein each one of the signals from the at least one target node occupies an entire preconfigured bandwidth used for node-to-node signalling in the OTDOA positioning process; and
report, as part of the synchronization process, to the wireless communication system, a time of receipt of a signal from each one of the at least one target node.

34. The apparatus according to claim 33, wherein each one of the signals from the at least one target node comprises an automatic gain control symbol transmitted at a preconfigured power.

35. The apparatus according to claim 34, wherein each one of the signals from the at least one target node is an uplink or a sidelink signal.

36. The apparatus according to claim 35, wherein the apparatus is configured to receive the signal from the at least one target node before transmitting the reference signal.

37. The apparatus according to claim 35, wherein the apparatus is configured to receive the signal from the at least one target node after transmitting the reference signal.

38. A system comprising:
an apparatus;
at least one processing core; and
at least one memory storing instructions that, when executed by the at least one processing core, cause the apparatus at least to:
function as a node in a wireless communication system;
participate in a synchronization process with at least one target node of the wireless communication system, wherein the apparatus is configured to transmit, as part of the synchronization process, via node-to-node signalling, a reference signal at a time instant specified in assistance information received from the wireless communication system, wherein the synchronization process is comprised in an observed time difference of arrival (OTDOA) positioning process, wherein the at least one target node is positioned in the OTDOA positioning process, wherein the reference signal is a positioning reference signal and wherein the assistance information is positioning assistance information, wherein each one of the signals from the at least one target node occupies an entire preconfigured bandwidth used for node-to-node signalling in the OTDOA positioning process; and
report, as part of the synchronization process, to the wireless communication system, a time of receipt of a signal from each one of the at least one target node.

39. The system according to claim 38, wherein each one of the signals from the at least one target node comprises an automatic gain control symbol transmitted at a preconfigured power.

40. The system according to claim 39, wherein each one of the signals from the at least one target node is an uplink or a sidelink signal.

41. The system according to claim 40, wherein the apparatus is configured to receive the signal from the at least one target node before transmitting the reference signal.

42. The system according to claim 40, wherein the apparatus is configured to receive the signal from the at least one target node after transmitting the reference signal.

43. A method comprising:
functioning, by an apparatus, as a node in a wireless communication system;
participating, by the apparatus, in a synchronization process with at least one target node of the wireless communication system, wherein the apparatus is configured to transmit, as part of the synchronization process, via node-to-node signalling, a reference signal at a time instant specified in assistance information received from the wireless communication system, wherein the synchronization process is comprised in an observed time difference of arrival (OTDOA) positioning process, wherein the at least one target node is positioned in the OTDOA positioning process, wherein the reference signal is a positioning reference signal and wherein the assistance information is positioning assistance information, wherein each one of the signals from the at least one target node occupies an entire preconfigured bandwidth used for node-to-node signalling in the OTDOA positioning process; and
reporting, by the apparatus, as part of the synchronization process, to the wireless communication system, a time of receipt of a signal from each one of the at least one target node.

44. The method according to claim 43, wherein each one of the signals from the at least one target node comprises an automatic gain control symbol transmitted at a preconfigured power.

45. The method according to claim 44, wherein each one of the signals from the at least one target node is an uplink or a sidelink signal.

46. The method according to claim 45, wherein the apparatus is configured to receive the signal from the at least one target node before transmitting the reference signal.

47. The method according to claim 45, wherein the apparatus is configured to receive the signal from the at least one target node after transmitting the reference signal.
